(19) United States
(12) Patent Application Publication
(10) Pub. No.: US 2005/0286076 A1
(43) Pub. Date: Dec. 29, 2005

(54) Method and apparatus for printing barcodes and for generating barcode print commands

(75) Inventor: Young-Taek Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/129,507

(22) Filed: May 16, 2005

(30) Foreign Application Priority Data
Jun. 29, 2004 (KR) 2004-49707

(51) Int. Cl. G06F 15/00

(52) U.S. Cl. 358/1.15; 358/1.18; 358/1.12

(57) ABSTRACT

There are provided a method and apparatus for printing a barcode and a method and apparatus for generating a barcode image print command therefor. The barcode print method comprises the steps of receiving a barcode image print command comprising barcode image data; determining whether a key module allowing barcode printing exists; decoding the barcode image data if the key module allowing barcode printing exists; and printing the decoded barcode image data. Therefore, since the barcode print apparatus can print barcodes using an inexpensive key module instead of an expensive barcode module, it is possible to reduce the cost required for printing the barcodes.

### CROSS-REFERENCE TO RELATED APPLICATION

This application claims the benefit under 35 U.S.C. §119(a) of Korean Patent Application No. 2004-49707, filed on Jun. 29, 2004, in the Korean Intellectual Property Office, the entire disclosure of which is hereby incorporated by reference.

### BACKGROUND OF THE INVENTION

1. Field of the Invention

The present invention relates to a printer and print commands. More particularly, the present invention relates to a method and apparatus for printing a barcode and for generating a barcode print command therefor.

2. Description of the Related Art

Generally, a printer is used to print results processed by computers in the form of documents, and is a principle component in appliances such as a multifunction machine, a facsimile, an electronic cash register and an automated teller machine (ATM) among others.

Examples of printer types include a daisy-wheel printer, a dot pin printer, an ink-jet printer, a laser printer, and the like. The ink-jet printer and the laser printer are, in particular, most commonly used.

FIG. 1 is a block diagram of a conventional apparatus for generating and transmitting printer data in a host computer 100. Referring to FIG. 1, if an application program 100-1 of the host computer 100 sends data (printer data) to be printed to a printer driver 100-3 via a Graphic Device Interface (GDI) 100-2, the print driver 100-3 converts the printer data to a print command capable of being processed by a printer 200 and transmits the print commands to the printer 200.

The printer driver 100-3 is a computer program for converting documents or graphic files made by a computer to print command capable of being interpreted by a printer. The manufacturer of the printer typically provides the print driver 100-3.

Printing barcodes is one of the applications of a printer. Barcodes are used to encode serial numbers of products and other product information.

The types of barcodes include one-dimensional barcodes, such as Code 128, two-dimensional barcodes, such as PDF417, and the like. Generally, the one-dimensional barcode represents specific information, such as the serial numbers of products, by using combinations of bars and spaces (that is, spaces between bars).

A barcode scanner is provided to decode information, such as a serial number, into a human-readable format from a printed barcode. To print a barcode, a print command including such barcode data should be transmitted to a printer.

A character or a set of characters (hereafter referred to as barcode characters) is input and a type of barcode is assigned based on the barcode characters by using, for example, a word processor. Barcode data, which comprises barcode characters and a barcode type identifier, is converted and transmitted to a printer. The printer prints a barcode image corresponding to the barcode data. One-dimensional barcode images are expressed using a plurality of bars and spaces.

FIG. 2 illustrates the configuration of a conventional barcode print system. In FIG. 2, the reference number 100 represents a host computer that generates printer data, the reference number 200 represents a printer and the reference number 300 represents a barcode module that provides barcode font information to the printer 200. The barcode module 300 is installed in the printer 200 and stores the barcode font information.

The host computer 100 transmits printer data including barcode data to the printer 200. The printer data is transmitted in the form of a printer control command, such as PCL1, PCL2, PCL4, PCL5e, or a similar printer control language. Only PCL5e from among those types listed natively supports barcodes. Accordingly, the host computer 100 transmits barcode data using a print control command of PCL5e. Therefore, the printer 200 must include an emulator for processing the printer control command of PCL5e.

If the printer 200 receives a printer control command including barcode data, the printer 200 obtains barcode font information corresponding to the barcode character from the barcode module 300. The printer 200 uses the barcode font information to generate a barcode image and print the barcode image.

FIG. 3 is a flowchart illustrating a barcode print method used in the conventional printer 200.

First, the printer 200 receives printer data transmitted from the host computer 100 (step S302).

Then, the printer 200 analyzes the printer data. In detail, the printer 200 parses the printer data and determines whether barcode data is included in the parsed printer data (step S304).

If it is determined, in step S304, that barcode data is included in the parsed printer data, the printer 200 determines whether a barcode module 300 is installed (step S306). If it is determined that a barcode module is not installed, the printing operation is terminated.

If it is determined in step S304 that a barcode module 300 is installed, the printer 200 requests the barcode module 300 to transmit barcode fonts corresponding to the barcode character and loads barcode fonts provided from the barcode module 300 (step S308). The barcode module 300 provides barcode fonts to the printer 200 according to a request of the printer 200.

The printer 200 creates a barcode image using the loaded barcode fonts (step S310) and prints the created barcode image (step S312).

All types of printer drivers do not support a barcode print function. To print barcodes, a printer driver for converting barcode data to a print command according to a barcode protocol is needed and also a corresponding printer should support an emulation mode providing the barcode print function.

Recent printers provide various and high quality printouts. However, the standard print drivers for printers use an escape (Esc) sequence and support only a few functions for printing English capital and lower-case letters, numeral letters and several symbols, and magnifying them up to twice than their own size in the vertical and horizontal directions. To provide additional printing functions that are not supported by standard print drivers, respective printer manufacturers use different methods. For example, methods for providing additional functions may include using an extended Esc sequence, using separate print languages, such as a PCL (Print Control Language), PostScript, or the like.

A PCL developed by Hewlett-Packard Co. (US) is among the most widely used print languages. The PCL developed by Hewlett-Packard Co. has evolved from PCL1 to PCL4, PCL5 and PCL5e of which PCL4, PCL5, PCL5e are the most commonly used. A laser printer comprises a memory and a microprocessor for interpreting and converting printer languages, such as PCL1-PCL5e to images.

A method for allowing a printer to support various printing methods provided by other manufacturers for providing wide-range compatibility is called emulation. Emulation methods have different modes such as LQ mode, KS mode, KSSM mode, and the like, which mainly process texts. The emulation modes, such as PCL mode, PostScript mode, and the like are mainly graphics processing emulators. Printer control language versions above PCL5e support a barcode printing function. Therefore, to print a barcode image, a printer driver and printer supporting the barcode print function should be installed.

In order to print barcodes according to the conventional method, a printer should comprise a barcode module having barcode fonts. In the conventional method, the printer reads the barcode fonts corresponding to a barcode character included in a print command from the barcode module in order to print the barcode. Generally, since the barcode module is implemented by an expensive flash memory, the conventional barcode print apparatus has relatively high installation costs.

Accordingly, a barcode protocol is needed and also a corresponding printer that supports an emulation mode for providing the barcode print function without incurring high installation costs and eliminating the need for a separate barcode module.

### SUMMARY OF THE INVENTION

The present invention provides a barcode print method allowing a printer to easily print barcodes.

The present invention also provides a printer in which the barcode print method is performed without a barcode module.

The present invention also provides a barcode print command generation method allowing a printer without a barcode module storing barcode fonts to print barcodes.

The present invention also provides a barcode image print command generation apparatus in which the barcode image print command generation method is performed.

According to an aspect of the present invention, there is provided a print method comprising the steps of receiving a barcode image print command comprising barcode image data; determining whether a key module allowing barcode printing exists; decoding the barcode image data if the key module allowing barcode printing exists; and printing the decoded barcode image data.

According to another aspect of the present invention, there is provided a printer comprising an interface for receiving a barcode image print command comprising barcode image data; a key module for indicating whether barcode printing is available; a decoding unit decoding barcode image data received through the interface according to whether the key module exists; and a controller for outputting the barcode image data decoded by the decoding unit through a printer engine.

According to still another aspect of the present invention, there is provided a method for generating a barcode image print command, comprising the steps of receiving a barcode data comprising barcode character and barcode font information; generating barcode image data for representing the barcode data with reference to barcode font database; and generating a barcode image print command including the barcode image data.

According to still yet another aspect of the present invention, there is provided a printer driver comprising a printer data receiving unit for receiving a barcode data including barcode character and barcode font information; a barcode image generation unit for reading barcode fonts representing a barcode character from a barcode font database and generating barcode image data; and a print command generation unit for generating a barcode image print command to transmit the barcode image data generated by the barcode image generation unit in an image data form.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for generating and transmitting printer data in a host computer;

FIG. 2 illustrates the configuration of a conventional barcode print system;

FIG. 3 is a flowchart illustrating a barcode print method used in a conventional printer;

FIG. 4 illustrates the configuration of a barcode print system according to an embodiment of the present invention;

FIG. 5 is a flowchart illustrating a barcode print method according to an embodiment of the present invention;

FIG. 6 is a block diagram of a printer according to an embodiment of the present invention;

FIG. 7 is a flowchart illustrating a method for generating a barcode image print command according to an embodiment of the present invention;

FIG. 8 shows an example of a barcode image print command according to an embodiment of the present invention;

FIG. 9 is a block diagram showing the configuration of a printer driver according to an embodiment of the present invention; and

FIG. 10 shows an example of a barcode image generated by a printer according to an embodiment of the present invention.

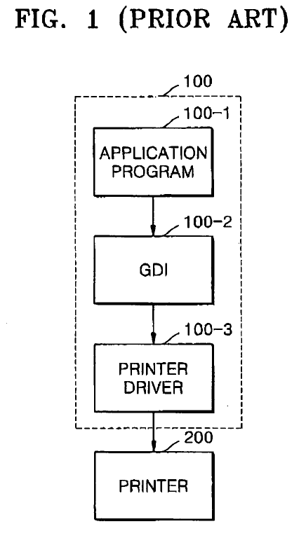

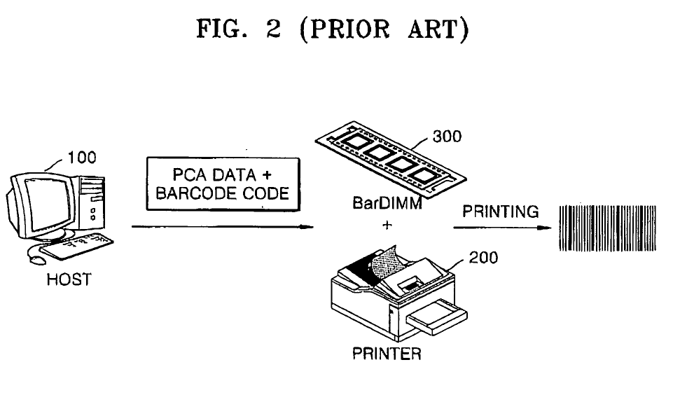

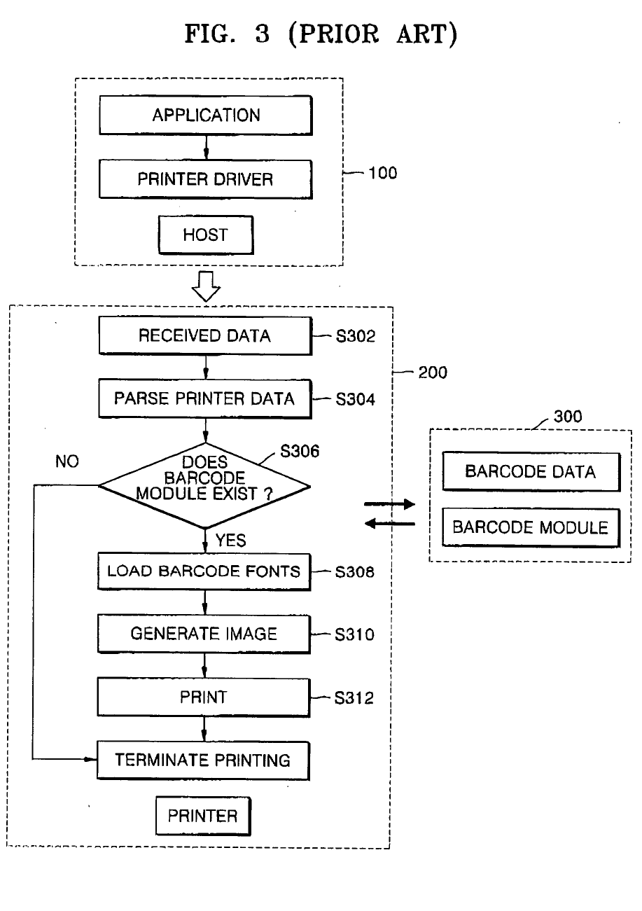

Throughout the drawings, it should be understood that like reference numbers refer to like features, structures, and elements.

### DETAILED DESCRIPTION OF EXEMPLARY EMBODIMENTS

Hereinafter, embodiments of the present invention will be described in detail with reference to the appended drawings. Descriptions for well-known techniques in the art are have been omitted for the sake of clarity and convenience.

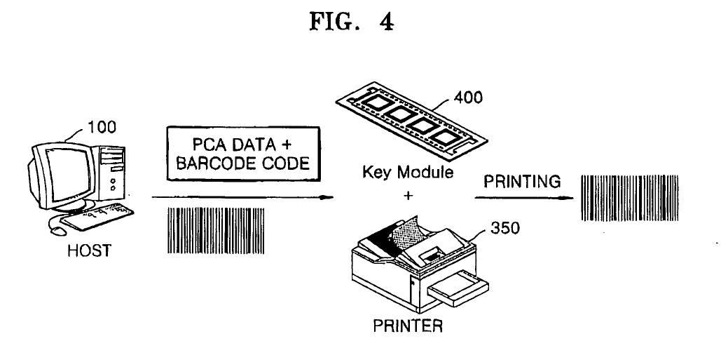

FIG. 4 illustrates the configuration of a barcode print system according to the present invention. In FIG. 4, reference number 100 represents a host computer which generates barcode image data, reference number 350 represents a printer and reference number 400 represents a key module for providing information indicating whether barcode printing is available, to the printer 350. The key module 400 is installed in the printer 350.

The host computer 100 transmits printer data comprising barcode image data to the printer 350. The printer data is transmitted in the form of a printer control command. The available types of print control command languages include PCL1, PCL2, PCL4, PCL5e, PostScript and the like.

If receiving a printer control command comprising barcode image data, the printer 350 determines whether a key module 400 exists and, if a key module 400 exists, the printer 350 decodes to print the barcode image data.

The barcode image data transmitted from the host computer 100 may be encoded data. In this case, the printer 350 determines whether a key module 400 exists. If the printer 350 detects a key module 400, the printer 350 decodes to output the encoded barcode image data.

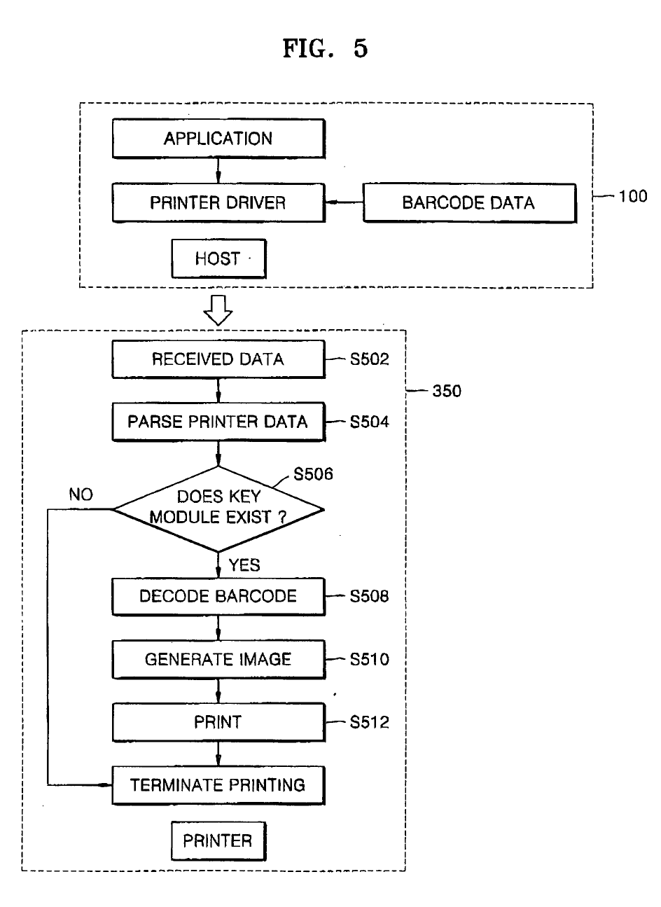

FIG. 5 is a flowchart illustrating a barcode print method according to the present invention.

Referring to FIG. 5, first, the printer 350 receives printer data transmitted from the host computer 100 (step S502). Here, the printer data comprises barcode image data.

Then, the printer 350 analyzes the printer data. In detail, the printer 200 parses the printer data and determines whether barcode image data comprises the parsed printer data (step S504).

If it is determined in step S504 that barcode image data is included in the parsed printer data, the printer 350 determines whether a key module 400 is installed (step S506). If it is determined in step S506 that key module 400 is not installed, the printing operation is terminated.

If it is determined in step S506 that a key module 400 is installed, the barcode image data is decoded (step S508). The barcode image data transmitted from the host computer 100 can be encoded data. In the above described embodiment, it is determined whether a key module 400 is installed and, if trge key module 400 is installed, the encoded barcode image data is decoded to be output. A predetermined encoding and decoding algorithm should be available to both the printer 350 and the printer driver. For that, a key module corresponding to a specific encoding algorithm should preferably be inserted into a slot with a specific number associated with the specific predetermined encoding and decoding algorithm in the printer 350. The printer 350 decodes the barcode image data according to a decoding algorithm decided by the associated specific number of the slot into which the key module 400 is inserted.

Then, the printer 200 generates a barcode image on the basis of the decoded barcode image data (step S510) and prints the generated barcode image (step S512).

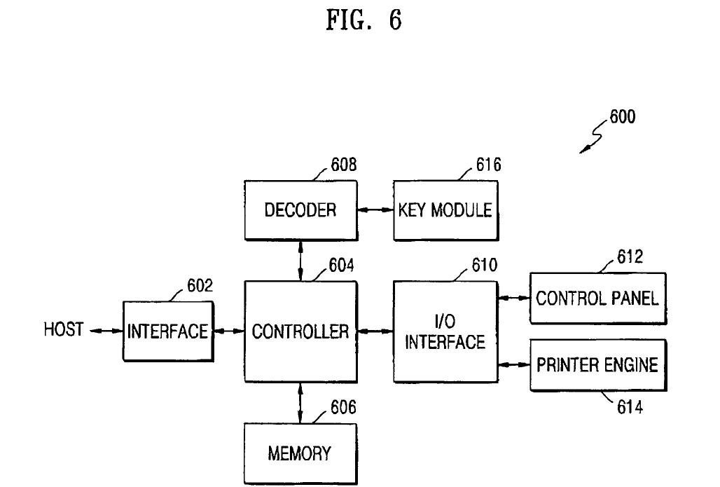

FIG. 6 is a block diagram of a printer 600 according to an embodiment of the present invention. Referring to FIG. 6, the printer 600 comprises an interface 602, a controller 604, a memory 606, a decoder 608, an I/O interface 610, a control panel 612, a printer engine 614 and a key module 616.

The control panel 612 comprises a plurality of keys through which a user inputs predetermined commands and a display device for displaying information for operations of the printer 600 to the user.

The interface 602 receives print commands from an external host computer (not shown), such as, various control commands, text print commands, image print commands, barcode image print commands, etc., and also facilitates sending signals (such as, state signals of the printer 600) to an external host computer. Print commands received from the host computer are buffered in the memory 606.

The controller 604 communicates with the host computer through the interface 602 and controls the memory 606, the decoder 608 and the printer engine 614 according to various commands received from the host computer and the control panel 612, thereby performing a printing operation.

The memory 606 stores user's setting information input through the control panel 612 and print commands received from the host computer under the control of the controller 604. The memory 606 also can store operation programs of the controller 604.

The decoder 608 decodes the barcode image data under the control of the controller 604. The decoder 608 performs a decoding operation with reference to the key module 616. In detail, the decoder 608 determines whether a key module 616 is installed and into which slot the key module 616 is installed. If the barcode image data is encoded data, the decoder 608 decodes the barcode image data using a corresponding decoding algorithm.

In an embodiment of the present invention, the decoder 608 is implemented by a separate component, but can be implemented by a decoding program. Such a decoding program can be stored in the memory 606 and executed by the controller 604.

The I/O interface 610 is connected to the controller 604, the control panel 612 and the printer engine 614 to convert an input/output signal of the controller 604. Text print commands, image print commands, barcode image print commands processed by the decoder 608, and the like, which are stored in the memory 606, are transmitted to the printer engine 614 via the I/O interface 610.

The printer engine 614 for printing printer data can include various mechanical devices for transferring papers and printing data, and for performing printing operations under the control of the controller 604.

The printer 600 according to an embodiment of the present invention, as shown in FIG. 6, can print barcodes without an expensive barcode module for storing barcode fonts.

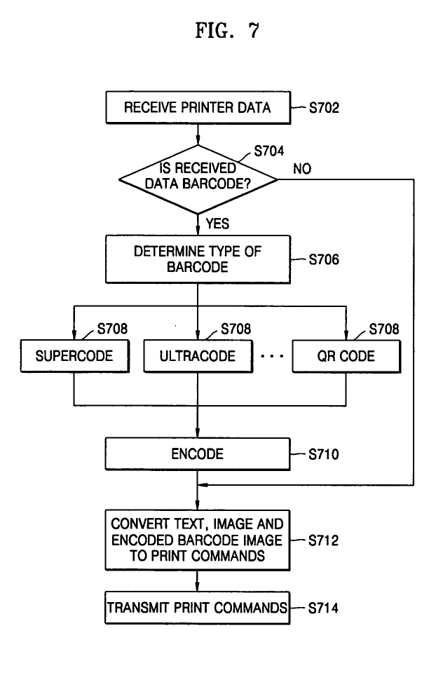

FIG. 7 is a flowchart illustrating a method for generating a barcode image print command, according to an embodiment of the present invention. Referring to FIG. 7, first, a printer driver receives printer data including texts, images, barcode data, and the like (step S702). The barcode data can include barcode character and barcode font information.

The printer driver sequentially parses the printer data and determines whether the parsed printer data is barcode data (step S704). If it is determined in step S704 that the parsed printer data is not a barcode data, the printer driver converts and outputs the received printer data to a print command for printing a text or an image as described above (step S706).

If it is determined in step S704 that the parsed printer data is barcode data, the printer driver determines the type the barcode is to be printed, such as supercode, ultracode, QR code or any other suitable barcode (step S708).

The determinations, for whether the printer data is barcode data and the type of barcode that is to be printed, are carried out on the basis of barcode font information. The barcode fonts are designated when a barcode application, such as a word processor, creates barcodes. Accordingly, the printer driver can determine whether the printer data is barcode data and which type of barcode is to be printed on the basis of the barcode font information.

The printer driver generates barcode image data corresponding to the type of the barcode and the barcode character determined in step S708. Since the barcode font information is preserved by the operating system, the printer driver generates the barcode image data with reference to the barcode font information.

The printer driver encodes the barcode image data according to a predetermined encoding algorithm (step S710). Here, the text data, the image data, and the encoded barcode image data are converted into print commands (step S712).

The printer driver outputs the print commands to the printer (step S714). Here, a print command that has barcode image data is preferably referred to as a barcode image print command,

In the barcode image print command generation method according to an embodiment of the present invention, as shown in FIG. 7, barcode data is converted to barcode image data and print commands including the barcode image data are transmitted to the printer, unlike the conventional method.

The barcode image print commands according to an embodiment of the present invention do not need to be adapted to an emulation method supporting a barcode print function. Emulation is not needed because the barcode image data corresponding to the barcode data is transmitted to a printer using an emulation method for supporting more common image print functions.

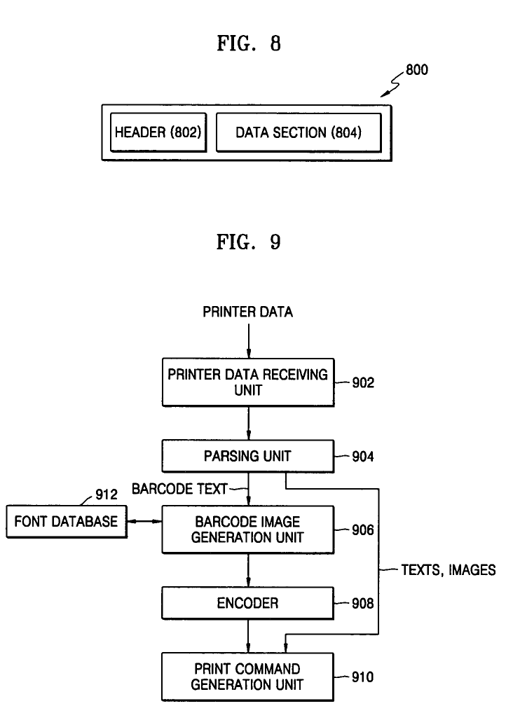

FIG. 8 shows an example of a barcode image print command according to an embodiment of the present invention.

Referring to FIG. 8, a barcode image print command 800 according to an embodiment of the present invention preferably can include a header 802 and a data section 804. The header 802 can include information for distinguishing the barcode image data from general image data. Barcode image data included in the data section 804 is preferably encoded by a predetermined encoding algorithm in order to prevent the barcode image data from being obtained by unauthorized methods.

FIG. 9 is a block diagram showing the configuration of a printer driver according to an embodiment of the present invention.

The printer driver shown in FIG. 9 comprises a printer data receiving unit 902, a parsing unit 904, a barcode image generator 906, an encoder 908 and a print command generator 910.

The printer data receiving unit 902 receives printer data from an application program. The printer data can include text, image and barcode data.

The parsing unit 904 divides the text, the image and the barcode data from the printer data. The barcode data parsed by the parsing unit 904 is transmitted to the barcode image generator 906 and the parsed text and image data is transmitted to the print command generator 910.

The barcode image generator 906 determines the type of barcode on the basis of barcode font information, and reads the barcode font for representing the barcode character from a font database 912 according to the determined type of the barcode and the barcode character, thereby generating barcode image data.

The font database 912 shown in FIG. 9 is preferably implemented as a font area preserved by an operating system. The barcode image generator 906 reads the barcode font from the preserved font area according to the determined type of the barcode and the barcode character and combines the barcode font, thereby generating barcode image data.

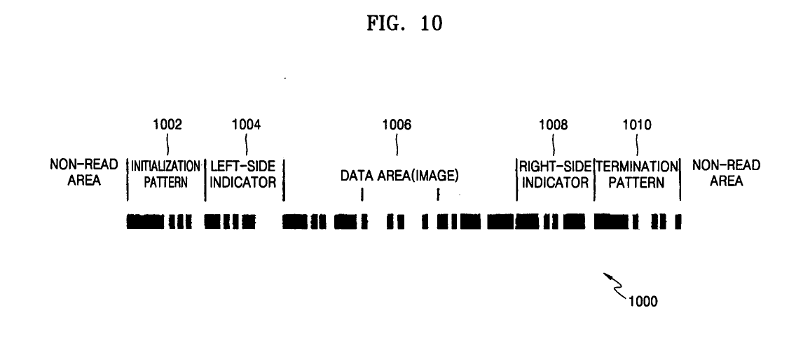

FIG. 10 shows an example of a barcode image 1000. Referring to FIG. 10, the barcode image 1000 can include a start pattern 1002, a left-side indicator 1004, a right-side indicator 1008, and a stop pattern 1010, and other typical barcode fields, depending on the type of barcode, as well as a data area 1006 corresponding to the barcode character.

The encoder 908 of FIG. 9 encodes barcode image data generated from the barcode image generator 906 according to a predetermined encoding algorithm.

The print command generator 910 generates print commands corresponding to the text data, the image data and the encoded barcode image data. The encoded barcode image data is converted to a barcode image print command with formats as shown in FIG. 4.

As described above, since the barcode print apparatus according to embodiments of the present invention can print barcodes using an inexpensive key module instead of an expensive barcode module, it is possible to reduce the cost required for printing the barcodes.

Also, the printer according to embodiments of the present invention does not require an emulation mode for printing barcodes.

Also, in the barcode print command generation method according to embodiments of the present invention, since encoded barcode image data is decoded and output, it is possible to prevent the barcode image data from being leaked by iniquitous method.

While embodiments of the present invention has been particularly shown and described with reference to exemplary embodiments thereof, it will be understood by those of ordinary skill in the art that various changes in form and details may be made therein without departing from the spirit and scope of the present invention as defined by the following claims.

1. A print method comprising:
receiving a barcode image print command comprising barcode image data;
determining whether a key module allowing barcode printing exists;
decoding the barcode image data if the key module allowing barcode printing exists; and
printing the decoded barcode image data.

2. The method of claim 1, wherein the barcode image data is encoded data and the decoding of the barcode image data is performed based on whether the key module exists.

3. A printer comprising:
an interface for receiving a barcode image print command comprising barcode image data;
a key module for indicating whether barcode printing is available;
a decoding unit for decoding barcode image data received through the interface according to whether the key module exists; and
a controller for outputting the barcode image data decoded by the decoding unit through a printer engine.

4. The printer of claim 3, wherein the barcode image data is encoded data and the decoding unit decodes the encoded data according to whether the key module exists.

5. A method for generating a barcode image print command, comprising the steps of:
receiving barcode data comprising barcode character and barcode font information;
generating barcode image data for representing the barcode data with reference to barcode font database; and
generating a barcode image print command comprising the barcode image data.

6. The method of claim 5, wherein the barcode image print command comprises:
a header having information indicating that the print command includes barcode image data; and
a data section including the barcode image data.

7. The method of claim 5, wherein the step of generating barcode image data further comprises the steps of:
encoding the generated barcode image data; and
transmitting the encoded barcode image data in an image data form.

8. A printer driver comprising:
a printer data receiving unit for receiving a barcode data comprising barcode character and barcode font information;
a barcode image generation unit for reading barcode font information for representing a barcode character from a barcode font database and generating barcode image data; and
a print command generation unit for generating a barcode image print command to transmit the barcode image data generated by the barcode image generation unit in an image data form.

9. The printer driver of claim 8, wherein the print command generation unit generates the print command comprising:
a header having information indicating that is the barcode image data is included; and
a data section including the barcode image data.

10. The printer driver of claim 8, further comprising:
an encoding unit for encoding the barcode image data generated by the barcode image generation unit according to a predetermined encoding algorithm,
wherein the print command generation unit generates a barcode image print command for transmitting the barcode image data encoded by the encoding unit in an image data form.

11. The printer driver of claim 8, wherein the barcode font database is a set of font preserved by an operating system executing a barcode application.
